(19) United States
(12) Patent Application Publication
(10) Pub. No.: US 2014/0184491 A1
(43) Pub. Date: Jul. 3, 2014

(54) SYSTEM AND METHOD FOR PROVIDING USER INTERFACE USING AN OPTICAL SCANNING

(71) Applicant: Hyundai Motor Company, Seoul (KR)

(72) Inventor: Sung Un Kim, Yongin (KR)

(73) Assignee: Hyundai Motor Company, Seoul (KR)

(21) Appl. No.: 14/027,755

(22) Filed: Sep. 16, 2013

(30) Foreign Application Priority Data
Dec. 27, 2012 (KR) 10-2012-0155361

(51) Int. Cl. G06F 3/01

(52) U.S. Cl. CPC G06F 3/017
USPC 345/156

(57) ABSTRACT

A system provides a user interface using an optical scan and the system includes a scan light and an optical sensor that detects whether the light radiated to an object in a vehicle from the scan light is dispersed. A processor controls the scan light to radiate light for a scan to a predetermined position at a predetermined time, estimates the position of dispersed light, and outputs a corresponding signal, when the optical sensor detects dispersion of the light, by comparing the detection time of the light, and the predetermined time and the radiation position of the scan light. The processor recognizes the shape or the motion of the object in the vehicle based on the signal and outputs a corresponding signal and operates the devices in the vehicle based on the signal.

### CROSS-REFERENCE TO RELATED APPLICATION

This application claims priority to and the benefit of Korean Patent Application No. 10-2012-0155361 filed in the Korean Intellectual Property Office on Dec. 27, 2012, the entire contents of which are incorporated herein by reference.

### BACKGROUND

(a) Field of the Invention

The present invention relates to a system and a method for providing a user interface, using an optical scan. More particularly, the present invention relates to a system and a method for providing a user interface, using an optical scan, which controls the devices in a vehicle by recognizing a gesture of a passenger in the vehicle.

(b) Description of the Related Art

Recently, vehicles are being equipped with various electronic devices for passenger convenience. Electronic devices such as a navigation system and a hands-free system for a mobile phone are mounted within the vehicle, including the electronic devices, which were usually mounted in the related art, such as a radio system and an air-conditioning system.

The electronic devices in recently developed vehicles provide user interfaces through predetermined buttons and touch screens. The devices are operated by contact of a passenger hand, finger, or the like. Further, such an action may interfere with safe driving, because it is based on the passenger's eyes and hand action. Therefore, a technology has been developed that recognizes the position or the motion of a hand by measuring a distance and detecting a speed, using ultrasonic wave sensors.

Further, a conventional method includes indirectly detecting whether there is a hand or the position of a hand by detecting a signal, which is blocked or reflected by the hand, using an infrared beam. In addition, another conventional method includes recognizing that there is a hand within a predetermined distance from the user interface, by electrically recognizing an approach of the hand, using a capacitance sensor. In another conventional method, the method includes recognizing a gesture by transmitting and receiving electric waves, such as an antenna, using conductivity of a human body. Further, another method includes recognizing the shape of a hand or movement of a hand, using an imaging device (e.g., a camera). However, in the above conventional methods the systems are complicated and expensive due to expensive imaging devices or required image recognition equipment.

The above information disclosed in this section is only for enhancement of understanding of the background of the invention and therefore it may contain information that does not form the prior art that is already known in this country to a person of ordinary skill in the art.

### SUMMARY

The present invention provides a system and a method having advantages of being able to recognize a gesture of a passenger, using a relatively low-cost optical scan and thus to control various electronic devices in a vehicle.

An exemplary embodiment of the present invention provides a system for providing a user interface using an optical scan, which may include: a scan light; an optical sensor that detects whether the light radiated toward an object within a vehicle from the scan light is dispersed; a signal processing module that operates the scan light to radiate light for a scan to a predetermined position at a predetermined time, and estimates the position of dispersed light and outputs a corresponding signal, when the optical sensor detects dispersion of the light, by comparing the detection time of the light, and the predetermined time and the radiation position of the scan light; a recognizing unit that recognizes the shape or the motion of the object within the vehicle based on the signal from the signal processing module and outputs a corresponding signal; and an electronic control unit that operates the devices in the vehicle based on the signal from the recognizing unit.

The scan light may radiate infrared lasers. The scan light may include: a laser source that radiates the infrared lasers; and a micro-mirror controlled by the signal processing module to reflect the lasers from the laser source to a predetermined position at a predetermined time.

The system for providing a user interface using an optical scan according to an exemplary embodiment of the present invention may further include an information database that stores the recognized shape or motion of the object within the vehicle and device operation information that corresponds to the shape or the motion and the recognizing unit may compare the device operation information with the recognized shape or motion in the database, and may output a corresponding signal, when the recognized shape or motion correspond to device operation information input in advance.

The system for providing a user interface using an optical scan according to an exemplary embodiment of the present invention may further include an output unit that displays the operations of the devices in a vehicle by the electronic control unit.

Another exemplary embodiment of the present invention provides a method of providing a user interface using an optical scan, which may include: radiating lasers to predetermined positions at predetermined time; detecting dispersion of the lasers; comparing the detection time of the lasers with the radiation time of the lasers and recording the radiation positions of the lasers at a corresponding time, when dispersion of the lasers is detected; recognizing the shape or motion of an object within a vehicle based on the radiation positions of the lasers; comparing a signal corresponding to the recognized shape or motion of the object with device operation information input in advance, and outputting a corresponding signal, when the recognized shape or motion of the object corresponds to the device operation information input in advance; and operating a corresponding device based on the output signal.

The method of providing a user interface using an optical scan according to an exemplary embodiment of the present invention may further include determining whether a request exists for using the function of operating the user interface using an optical scan, before the radiating of lasers, and when a request exists for using the function of operating the user interface using an optical scan, radiating lasers to predetermined positions at a predetermined time may be performed.

The method of providing a user interface using an optical scan according to an exemplary embodiment of the present invention may further include determining whether a request exists for stopping the use of the function of operating a user interface using an optical scan, and stopping the function of operating the user interface using an optical scan, when a request exists for stopping the use of the function of operation the user interface using an optical scan.

The radiating lasers to predetermined positions at a predetermined time may be performed by a laser source that radiates infrared lasers and a micro-minor that reflects lasers from the laser source to predetermined positions at a predetermined time.

The system and the method for providing a user interface using an optical scan according to an exemplary embodiment of the present invention may recognize gestures of a passenger in a vehicle, using an optical scan, and control devices in the vehicle. The system and the method for providing a user interface using an optical scan according to an exemplary embodiment of the present invention may further recognize gestures of a passenger in a vehicle and control devices in the vehicle, without an additional excessive increase in cost, due to the use of a relatively low-cost scan.

### BRIEF DESCRIPTION OF THE DRAWINGS

FIG. 1 is an exemplary view showing a portion of the configuration of a system for providing a user interface using an optical scan according to an exemplary embodiment of the present invention;

FIGS. 2 and 3 are exemplary views illustrating a process of optical scan of the system for providing a user interface using an optical scan according to an exemplary embodiment of the present invention;

FIG. 4 is an exemplary block diagram illustrating the system for providing a user interface using an optical scan according to an exemplary embodiment of the present invention; and

FIG. 5 is an exemplary flowchart illustrating a method of providing a user interface using an optical scan according to an exemplary embodiment of the present invention.

Description of symbols

| | |
|---|---|
| 100: Scan light | 110: Laser source |
| 120: Micromirror | 200: Optical sensor |
| 300: Signal processing module | 400: Recognizing unit |
| 500: Electronic control unit | 600: Information data base |
| 700: Output unit | |

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

Furthermore, control logic of the present invention may be embodied as non-transitory computer readable media on a computer readable medium containing executable program instructions executed by a processor, controller or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Hereinafter, exemplary embodiments of the present invention will be described in detail with reference to the accompanying drawings. As those skilled in the art would realize, the described embodiments may be modified in various different ways, all without departing from the spirit or scope of the present invention. The configurations are optionally shown in the drawings for the convenience of description and the present invention is not limited to the drawings.

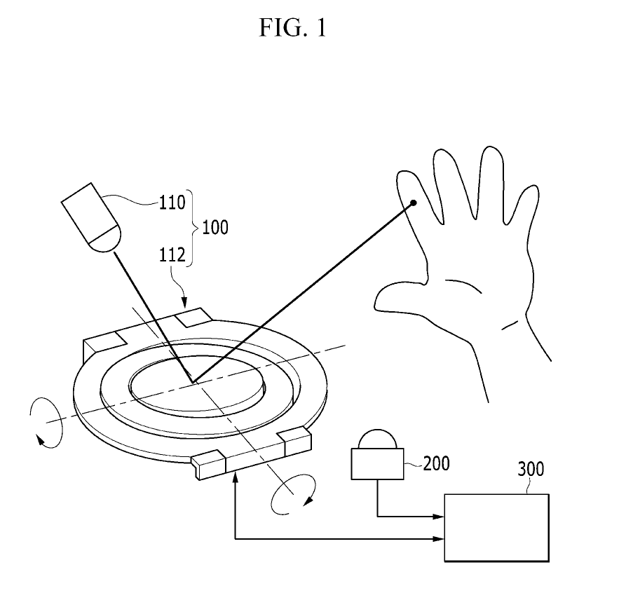

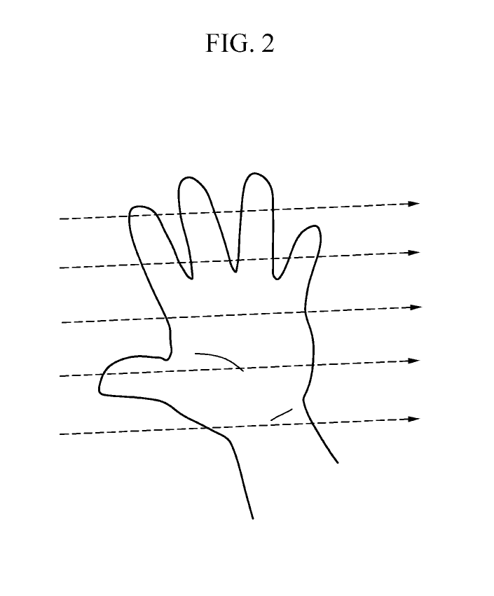

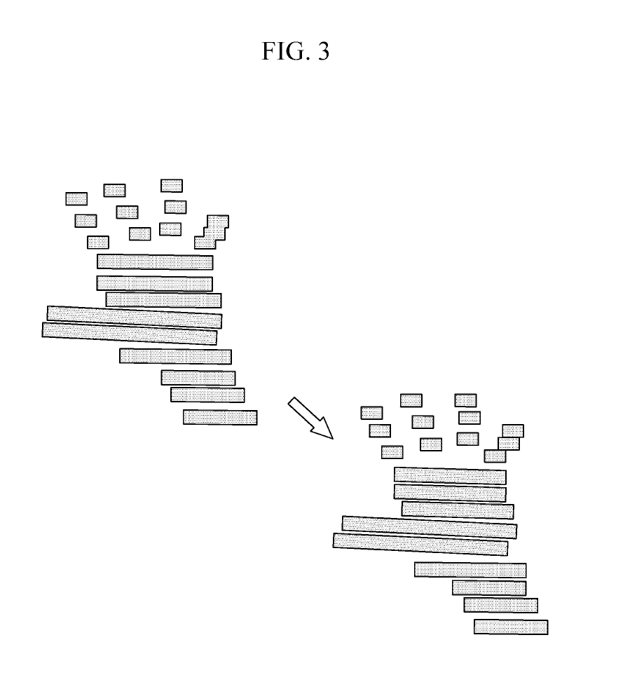

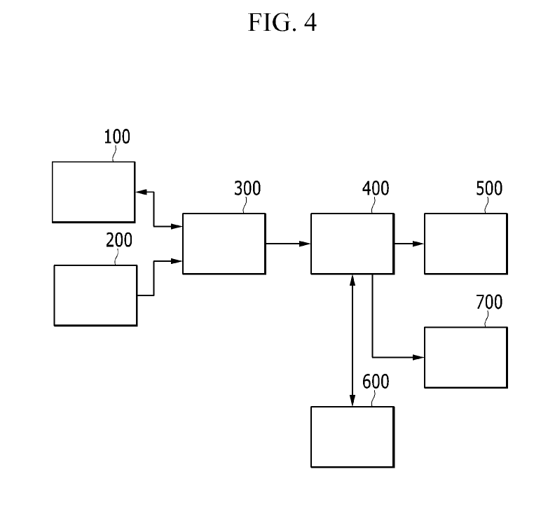

FIG. 1 is an exemplary view showing a portion of the configuration of a system for providing a user interface using an optical scan according to an exemplary embodiment of the present invention, FIGS. 2 and 3 are exemplary views illustrating a process of optical scan of the system for providing a user interface using an optical scan according to an exemplary embodiment of the present invention, and FIG. 4 is an exemplary block diagram illustrating the system for providing a user interface using an optical scan according to an exemplary embodiment of the present invention.

Referring to FIGS. 1 to 4, a system for providing a user interface (UI) using an optical scan according to an exemplary embodiment of the present invention may include: a scan light 100; an optical sensor 200 configured to detect whether the light radiated to an object in a vehicle from the scan light 100 is dispersed; a signal processing module 300 (e.g., a processor) configured to control the operation of the scan light 100 to radiate light for a scan to a predetermined position at a predetermined time, and estimate the position of dispersed light and output a corresponding signal, when the optical sensor 200 detects dispersion of the light, by comparing the detection time of the light, and the predetermined time and the radiation position of the scan light 100; a recognizing unit 400 executed by the signal processing module 300 and configured to recognize the shape or the motion of the object in the vehicle based on the signal from the signal processing module 300 and output a corresponding signal; and an electronic control unit 500 configured to operate the devices in the vehicle based on the signal from the recognizing unit 400. Although the signal processing module 300 and the electronic control unit 500 are described as separate devices, in some embodiments the signal processing module 300 and the electronic control unit 500 may be combined as one device.

The scan light 100 may be configured to radiate infrared lasers and may include a laser source 110 configured to radiate the infrared lasers and a micro-mirror 112 controlled by the signal processing module 300 to reflect the lasers from the laser source 110 to a predetermined position at a predetermined time.

The system for providing a user interface using an optical scan according to an exemplary embodiment of the present invention may further include an information database 600 configured to store the recognized shape or motion of the object in the vehicle and device operation information corresponding to the shape or the motion. The recognizing unit 300 may be configured to compare the device operation information in the database 600 with the recognized shape or motion and output a corresponding signal, when the recognized shape or motion corresponds to device operation information input in advance.

The electronic control unit 500 may be configured to provide user desired operations, by generating control signals for the operation of selected devices in the vehicle. For example, the selectable operations of the devices in the vehicle may be song selection, power-on/off, volume-up, answering/turning off a mobile phone, play/stop/mute of music, air conditioner-on/off, heater-on/off, and operation of sun visor and the like.

The recognized shape or motion of the object in the vehicle may be, for example, as shown the figures, the shape of a hand and a gesture of a hand and the information database 600, executed by the signal processing module 300, may be configured to store the gesture information of a hand that corresponds to changes in predetermined various hand motions and wrist angles. Further, the information database 600 may be configured to store device operation information that corresponds to the gesture information of a hand, if necessary.

For example, the operations of the devices in a vehicle which may be selected by a flicking motion to the left, a flicking motion to the right, a waving motion, and a turning of a hand motion to control device operations such as song selection to the left/right, power-on/off, and volume-up/down, and in addition, various device operations such as stop of music, music-on/off, pause of music, and air conditioner-on/off are possible for various wrist gestures.

The stored gesture information of a hand may be set in advance or gesture information of a hand registered by a passenger may be stored. A passenger may select and store the information regarding various changes of a hand as hand gestures. In other words, passengers may directly input changes regarding the angle of their wrists through wrist gestures to allow the information regarding the changes of different portions of bodies, for example, in wrist angle to be recognized without an error (e.g., with minimal error).

The system for providing a user interface using an optical scan according to an exemplary embodiment of the present invention may further include an output unit 700 operated by the electronic control unit 500 to display the operations of the devices in a vehicle. The output unit 700 may include a touch screen, a speaker, and operations of a mobile phone, a music player, an air conditioner, a heater, a sun visor, and contents which are objects for the operation of the devices in a vehicle. Further, the output unit may be configured to output the operations of the device in a vehicle on a display device.

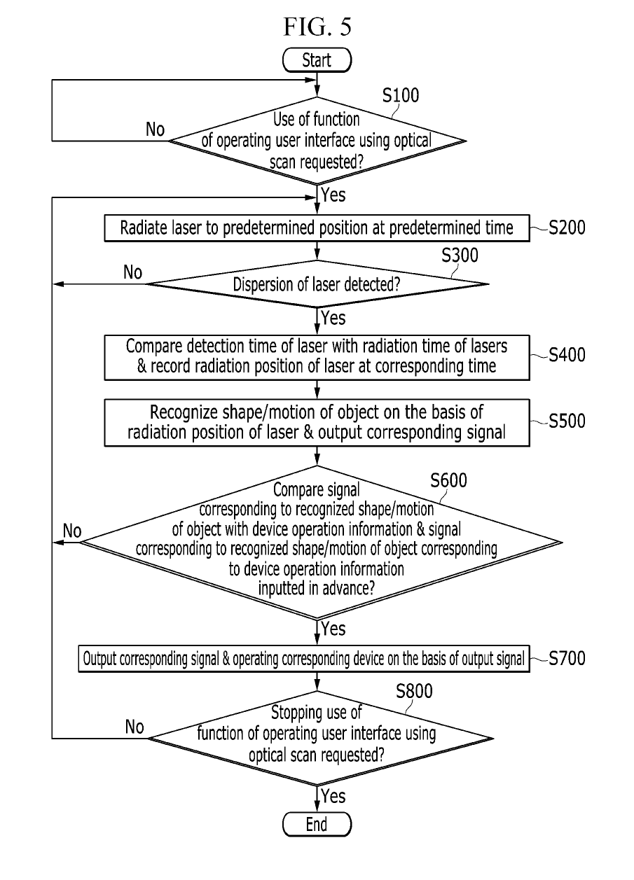

FIG. 5 is an exemplary flowchart illustrating a method of providing a user interface using optical scan according to an exemplary embodiment of the present invention. Hereinafter, a method of providing a user interface using an optical scan according to an exemplary embodiment of the present invention is described.

The signal processing module 300 may be configured to operate the scan light 100 to radiate light for a scan to a predetermined position at a predetermined time (S200). For example, the signal processing module 300 may be configured to operate the micro-minor 112 to reflect the light from the laser source 110 to a predetermined position at a predetermined time. The laser source 110 may be an infrared laser source and may sequentially radiate infrared lasers horizontally and vertically to predetermined positions.

The signal processing module 300 may be configured to determine whether the optical sensor 200 detects dispersion of light (S300). As shown in FIGS. 2 and 3, when lasers radiated from the infrared laser source reach an object in a vehicle, for example, a hand, dispersion may be generated at the portion that receives the laser. In other words, the optical sensor 200 may be configured to output and supply a corresponding signal to the signal processing module 300, when the infrared lasers reaching the object in the vehicle are dispersed.

When the dispersion of light is detected, the signal processing module 300 may be configured to compare the detection time of the lasers with the radiation time of the lasers and record the radiation positions of the lasers. The signal processing module 300 may further be configured to recognize the shape or motion of the object in the vehicle based on the radiation positions of the lasers and output corresponding signals (S500).

The recognizing unit 400, executed by the signal processing module 300, may be configured to compare the signals that correspond to the recognized shape or motion of the object with device operation information input in advance, and output corresponding signals, when the signals that correspond to the recognized shape or motion correspond to the device operation information input in advance (S600). The recognized shape or motion of the object in the vehicle may be, for example, as shown the figures, the shape of a hand and a gesture of a hand, the information database 600 may be configured to store the gesture information of a hand that corresponds to changes in predetermined various hand motions and wrist angles, and the recognizing unit 400 may be configured to compare the hand motion, as shown in FIG. 3, with various hand motions defined in advance in the information database 600 and output device operation information that corresponds to the information on the gesture of a hand.

The electronic control unit 500 may be configured to operate a corresponding device based on the output signal (S700). For example, the operations of the devices in a vehicle are device operations such as song selection to the left/right, power-on/off, and volume-up/down, and in addition, various device operations such as stop of music, music-on/off, pause of music, and air conditioner-on/off may be possible for various wrist gestures.

The stored gesture information of a hand may be set in advance or gesture information of a hand registered by a passenger may be stored. A passenger may select and store the information on various changes of a hand as hand gestures.

The signal processing module 300 may be configured to determine whether there is a request for using the function of operating a user interface using an optical scan, before the lasers are radiated (S100), and in response to detecting a request for using the function of operating the user interface using an optical scan, the signal processing module 300 may be configured to radiate a laser to a predetermined position at a predetermined time. The request for using the function of operating a user interface may be implemented through, for example, a button, a touch screen, a voice, and a gesture.

The method of providing a user interface using an optical scan according to an exemplary embodiment of the present invention may further include determining whether there is a request for stopping the use of the function of operating a user interface using an optical scan (S800), and may be configured to stop the function of operating the user interface using an optical scan, in response to detecting a request for stopping the use of the function of operation the user interface using an optical scan.

Although the configurations and functions of the signal processing unit 300, the recognizing unit 400, and the electronic control unit 500 were independently described for better comprehension and ease of description, the present invention is not limited thereto and it may be possible to implement the functions of the signal processing module 300, the recognizing unit 400, and the electronic control unit 500 with one ECU (Electronic Control Unit).

While this invention has been described in connection with what is presently considered to be exemplary embodiments, it is to be understood that the invention is not limited to the disclosed embodiments. On the contrary, it is intended to cover various modifications and equivalent arrangements included within the spirit and scope of the accompanying claims.

What is claimed is:

1. A system for providing a user interface using an optical scan, the system comprising:
a scan light;
an optical sensor configured to detect whether the light radiated to an object in a vehicle from the scan light is dispersed;
a processor configured to:
operate the scan light to radiate light for a scan to a predetermined position at a predetermined time;
estimate the position of dispersed light;
output a corresponding signal, when the optical sensor detects dispersion of the light, by comparing the detection time of the light, and the predetermined time and the radiation position of the scan light;
recognize the shape or the motion of the object in the vehicle based on the output signal; and
operate the devices in the vehicle based on the signal.

2. The system of claim 1, wherein the scan light is configured to radiate infrared lasers.

3. The system of claim 1, wherein the scan light includes:
a laser source configured to radiate the infrared lasers; and
a micro-mirror operated by the processor to reflect the lasers from the laser source to a predetermined position at a predetermined time.

4. The system of claim 1, wherein the processor is further configured to:
store the recognized shape or motion of the object in the vehicle and device operation information that corresponds to the shape or the motion in an information database;
compare the device operation information in the database with the recognized shape or motion; and
output a corresponding signal, when the recognized shape or motion corresponds to device operation information input in advance.

5. The system of claim 1, wherein the processor is further configured to display the operations of the devices in a vehicle on an output device.

6. A method of providing a user interface using an optical scan, the method comprising:
radiating, by a processor, lasers to predetermined positions at predetermined time;
detecting, by the processor, dispersion of the lasers;
comparing, by the processor, the detection time of the lasers with the radiation time of the lasers;
recording, by the processor, the radiation positions of the lasers at corresponding time, when dispersion of the lasers is detected;
recognizing, by the processor, the shape or motion of an object in a vehicle based on the radiation positions of the lasers;
comparing, by the processor, a signal that corresponds to the recognized shape or motion of the object with device operation information input in advance;
outputting, by the processor, a corresponding signal, when the recognized shape or motion of the object corresponds to the device operation information input in advance; and
operating, by the controller, a corresponding device based on the output signal.

7. The method of claim 6, further comprising:
determining, by the processor, whether there is a request for using the function of operating the user interface using an optical scan, before the radiating of lasers; and
in response to detecting a request for using the function of operating the user interface using an optical scan, radiating, by the processor, lasers to predetermined positions at a predetermined time is performed.

8. The method of claim 6, further comprising:
determining, by the processor, whether there is a request for stopping the use of the function of operating the user interface using an optical scan; and
in response to detecting a request for stopping the use of the function of operating the user interface using an optical scan, stopping, by the processor, the function of operating the user interface using an optical scan.

9. The method of claim 6, wherein the radiating lasers to predetermined positions at a predetermined time is performed by a laser source that radiates infrared lasers and a micro-minor that reflects lasers from the laser source to predetermined positions at a predetermined time.

10. A non-transitory computer readable medium containing program instructions executed by a processor or controller, the computer readable medium comprising:
program instructions that radiate lasers to predetermined positions at predetermined time;
program instructions that detect dispersion of the lasers;
program instructions that compare the detection time of the lasers with the radiation time of the lasers;
program instructions that record the radiation positions of the lasers at corresponding time, when dispersion of the lasers is detected;
program instructions that recognize the shape or motion of an object in a vehicle based on the radiation positions of the lasers;
program instructions that compare a signal that corresponds to the recognized shape or motion of the object with device operation information input in advance;
program instructions that output a corresponding signal, when the recognized shape or motion of the object corresponds to the device operation information input in advance; and
program instructions that operate a corresponding device based on the output signal.

11. The non-transitory computer readable medium of claim 10, further comprising:
program instructions that determine whether there is a request for using the function of operating the user interface using an optical scan, before the radiating of lasers; and
program instructions that radiate lasers to predetermined positions at a predetermined time is performed, in response to detecting a request for using the function of operating the user interface using an optical scan.

12. The non-transitory computer readable medium of claim 10, further comprising:
program instructions that determine whether there is a request for stopping the use of the function of operating the user interface using an optical scan; and
program instructions that stop the function of operating the user interface using an optical scan, in response to detecting a request for stopping the use of the function of operating the user interface using an optical scan.

13. The non-transitory computer readable medium of claim 10, wherein the radiating lasers to predetermined positions at a predetermined time is performed by a laser source that radiates infrared lasers and a micro-mirror that reflects lasers from the laser source to predetermined positions at a predetermined time.
